(19) United States
(12) Patent Application Publication
(10) Pub. No.: US 2012/0251966 A1
(43) Pub. Date: Oct. 4, 2012

(54) HEAT TREATMENT CONTROL SYSTEM AND HEAT TREATMENT CONTROL METHOD

(75) Inventors: Koji YOSHII, Oshu-Shi (JP); Tatsuya Yamaguchi, Sapporo-Shi (JP); Wenling Wang, Oshu-Shi (JP); Takanori Saito, Oshu-Shi (JP)

(73) Assignee: Tokyo Electron Limited, Minato-Ku (JP)

(21) Appl. No.: 13/429,845

(22) Filed: Mar. 26, 2012

(30) Foreign Application Priority Data
Mar. 30, 2011 (JP) 2011-075781

(51) Int. Cl. F27D 19/00

(52) U.S. Cl. 432/49

(57) ABSTRACT

There is provided a heat treatment control system and method which can accurately estimate the temperatures of wafers upon loading of the wafers, enabling quick heat treatment of the wafers. The heat treatment control system includes: a processing container for processing wafers held in a boat; a lid for hermetically closing the processing container; heaters for heating the processing container; and a controller for controlling the heaters. A profile temperature sensor holding tool is installed on the lid. To the sensor holding tool are mounted profile temperature sensors which are connected to a temperature estimation section. The temperature estimation section estimates the temperature of a wafer by applying a first-order lag filter to a detection signal from a profile temperature sensor. The controller controls the heaters based on the temperatures of wafers thus determined by the temperature estimation section.

### CROSS-REFERENCE TO RELATED APPLICATION

This application claims the priority benefit of Japanese Patent Application No. 2011-075781, filed on Mar. 30, 2011, the disclosure of which is incorporated herein by reference in its entirety.

### TECHNICAL FIELD

The present invention relates to a heat treatment control system and a heat treatment control method.

### BACKGROUND ART

In the manufacturing of semiconductor devices, various types of heat treatment apparatuses are used to perform heat treatments, such as oxidation, diffusion, CVD, annealing, etc. of processing objects, such as semiconductor wafers. Among them, a vertical heat treatment apparatus is known which is capable of heat treating a large number of processing objects at a time. The vertical heat treatment apparatus includes a quartz processing container having a bottom opening, a lid for opening and closing the opening of the processing container, a holding tool, provided on the lid, for holding a plurality of processing objects at predetermined intervals in the vertical direction, and a furnace body provided around the processing container and having a heater for heating the processing objects which have been carried into the processing container.

In the heat treatment apparatus, a controller, based on a signal from a temperature sensor provided in the processing container, controls the heater so that a processing object is heated to a predetermined set temperature. However, upon loading of the processing object, the temperature of the processing object gradually increases from room temperature. Thus, it takes a long time to heat the processing object up to a predetermined set temperature. Therefore, a demand exists to heat treat processing objects quickly and accurately especially upon loading of the processing objects.

### PRIOR ART DOCUMENT

Patent document 1: Japanese Patent No. 4,285,759

### SUMMARY OF THE INVENTION

The present invention has been made in view of the above situation. It is therefore an object of the present invention to provide a heat treatment control system and a heat treatment control method which can heat treat processing objects quickly and accurately upon loading of the processing objects.

In order to achieve the object, the present invention provides a heat treatment control system comprising: a furnace body; a heating section provided in the inner surface of the furnace body; a processing container disposed in the furnace body and having a bottom opening; a vertically movable lid for hermetically closing the bottom opening of the processing container; a holding tool, provided on the lid, for housing a plurality of processing objects (objects to be processed) and inserting the processing objects into the processing container; an in-container temperature sensor to be inserted into the processing container together with the processing objects to detect the internal temperature of the processing container; a temperature estimation section for estimating the temperature of a processing object (object to be processed) by applying a first-order lag filter to a detection signal from the in-container temperature sensor; and a controller for controlling the heating section based on the temperature of the processing object, estimated by the temperature estimation section.

In a preferred embodiment of the present invention, the in-container temperature sensor is provided on the lid.

In a preferred embodiment of the present invention, the in-container temperature sensor is mounted to a holding tool.

In a preferred embodiment of the present invention, the temperature estimation section estimates the temperature of the processing object upon loading of the processing object into the processing container.

The present invention also provides a heat treatment control method using the heat treatment control system, said method comprising the steps of: inserting and loading a processing object into the processing container by using the holding means for housing and holding the processing object; estimating the temperature of the processing object by means of the temperature estimation section by applying a first-order lag filter to a detection signal from the in-container temperature sensor; and controlling the heating section with the controller based on the temperature estimated by the temperature estimation section.

According to the present invention, the temperature of a processing object upon its loading can be accurately estimated by means of the temperature estimation section based on a detection temperature from the in-container temperature sensor. The controller controls the heating section based on the temperature of the processing object, estimated by the temperature estimation section. This makes it possible to heat treat the processing object quickly and accurately.

### BRIEF DESCRIPTION OF THE DRAWINGS

FIG. 1 is a vertical sectional view schematically showing a heat treatment control system according to an embodiment of the present invention;

FIG. 2 is a diagram corresponding to FIG. 1, showing the heat treatment control system upon loading of processing objects;

FIG. 3 is a diagram illustrating the action of the temperature estimation section of the heat treatment control system according to the present invention; and

FIG. 4(a) is a diagram illustrating the action of the temperature estimation section of the heat treatment control system according to the present invention, and FIG. 4(b) is a diagram illustrating the action of a comparative control system.

### DETAILED DESCRIPTION OF THE PREFERRED EMBODIMENTS

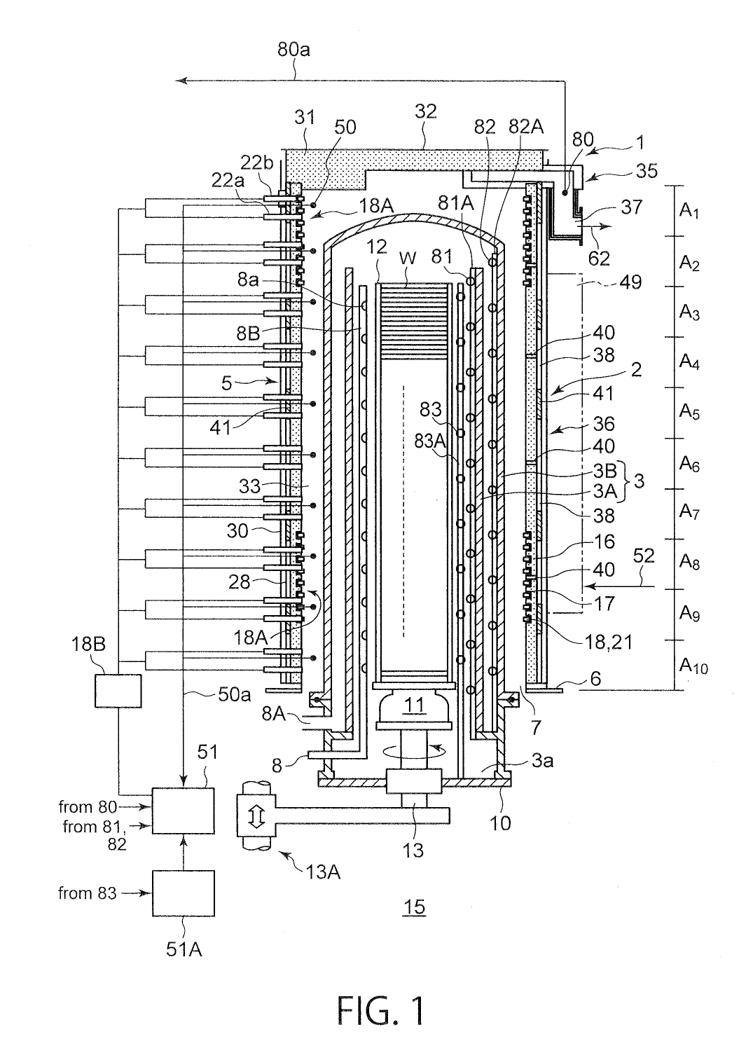

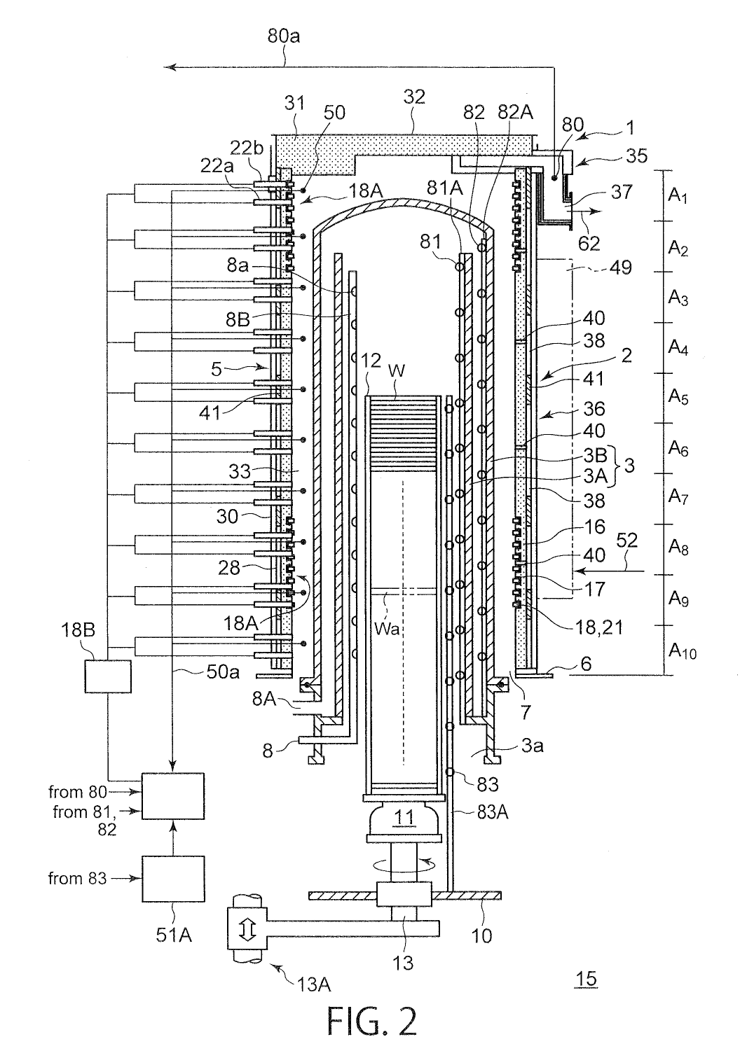

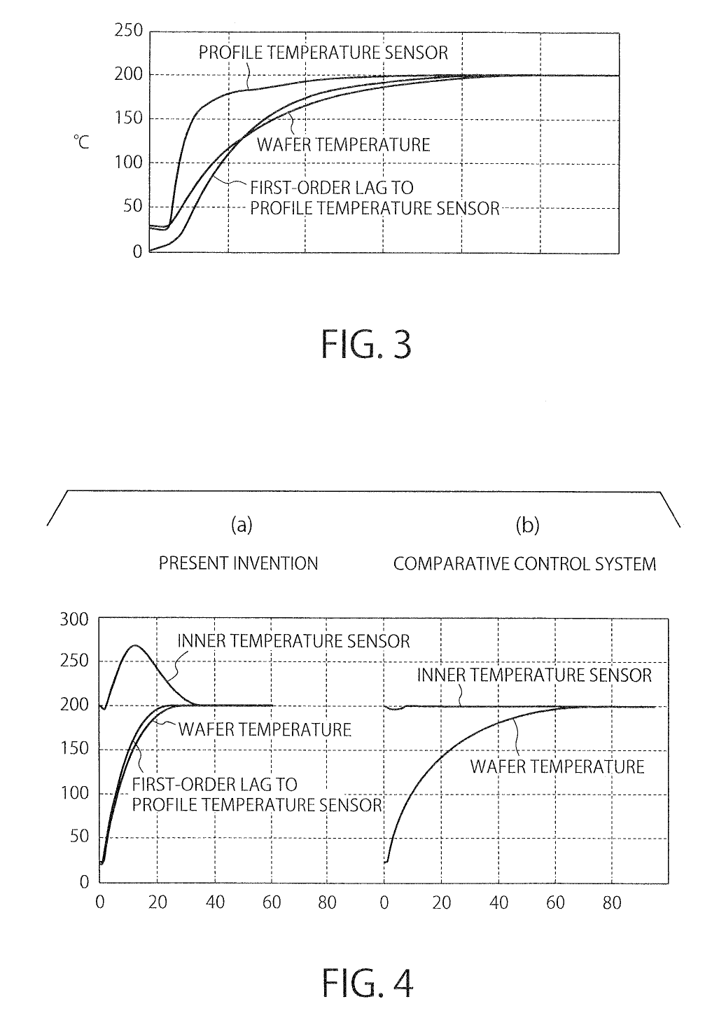

Preferred embodiments of the present invention will now be described with reference to the drawings. FIG. 1 is a vertical sectional view schematically showing a heat treatment control system according to the present invention; FIG. 2 is a diagram corresponding to FIG. 1, showing the heat treatment control system upon loading of processing objects; FIG. 3 is a diagram illustrating the action of the temperature estimation section of the heat treatment control system; and FIG. 4(a) is a diagram illustrating the action of the temperature estimation section of the heat treatment control system according to the present invention, and FIG. 4(b) is a diagram illustrating the action of a comparative control system.

Referring to FIG. 1, the vertical heat treatment control system 1 includes a vertical heat treatment furnace 2 which can house a large number of processing objects, e.g. semiconductor wafers W, and perform heat treatment, such as oxidation, diffusion or reduced-pressure CVD, of the processing objects. The heat treatment furnace 2 includes a furnace body 5 having, in its inner circumferential surface, heat generating resistors (heaters) 18A, and a processing container 3 for housing and heat treating the wafers W and which is disposed in the furnace body 5 and defines a space 33 between the processing container 5 and the furnace body 5. The heaters 18A function as a heating section for heating the wafers W.

The space 33 between the furnace body 5 and the processing container 3 is divided into a plurality of unit areas arranged in the vertical direction, for example, 10 unit areas A₁, A₂, A₃, A₄, A₅, A₆, A₇, A₈, A₉, A₁₀. The heaters 18A are each provided in each of the 10 unit areas A₁ to A₁₀. Further, each of the unit areas A₁ to A₁₀ is provided with an outer temperature sensor 50 for measuring the temperature of the unit area.

Thus, in the apparatus shown in FIG. 1, a heater 18A and an outer sensor 50 are provided in each of the unit areas A₁ to A₁₀. Each heater 18A is comprised of a plurality of heater elements 18 as will be described later.

The furnace body 5 is supported on a base plate 6 which has an opening 7 for inserting the processing container 3 from below. The opening 7 is provided with a not-shown heat insulator which covers the gap between the base plate 6 and the processing container 3.

The processing container 3 consists of a quartz inner cylinder 3A having an open top, and an outer cylinder 3B having a closed top and covering the inner cylinder 3A. The processing container 3 has, in a lower side portion, an introduction port 8 for introducing e.g. a processing gas or an inert gas into the processing container 3, and an exhaust port 8A for exhausting a gas from the processing container 3. The introduction port 8 is connected to a gas supply source (not shown), and the exhaust port 8A is connected to a vacuum system (not shown) including a vacuum pump capable of controllably depressurizing the processing container 3 e.g. to about 133×600 Pa to 133×10⁻² Pa. To the introduction port 8 is connected an introduction pipe 8B having jet ports 8a and extending in the processing container 3.

Below the processing container 3 is provided a lid 10 for closing the furnace opening 3a of the processing container 3 and which can be moved vertically by means of a lifting mechanism 13A. A heat-retaining cylinder 11 as a heat-retaining means for the furnace opening is placed on the upper surface of the lid 10, and a quartz boat 12 as a holding tool for holding a large number of, e.g. about 100 to 150, 300-mm semiconductor wafers W having a diameter of 300 mm at a predetermined spacing in the vertical direction, is placed on the upper surface of the heat-retaining cylinder 11. The lid 10 is provided with a rotating mechanism 13 for rotating the boat 12 on its axis. The boat 12 is carried (unloaded) from the processing container 3 downward into a loading area 15 by the downward movement of the lid 10 and, after replacement of wafers W, carried (loaded) into the processing container 3 by the upward movement of the lid 10.

The furnace body 5 includes a cylindrical heat insulator 16, and groove-like shelf portions 17 formed in the inner circumferential surface of the heat insulator 16 and arranged in multiple stages in the axial direction (vertical direction in the illustrated embodiment). Heater elements (heater wires, heat generating resistors) 18, constituting the heater 18A provided in each of the unit areas A₁ to A₁₀, are disposed in each shelf portion 17. The heat insulator 16 is composed of inorganic fibers, such as silica, alumina or alumina silicate. The heat insulator 16 is longitudinally halved to facilitate installation of the heater elements and assembly of the heaters.

The heat insulator 16 is provided with pin members (not shown) for holding the heater elements 18 at arbitrary intervals in such a manner as to allow radial movement of the heater elements 18. In the inner circumferential surface of the cylindrical heat insulator 16, annular grooves 21, which are concentric with the heat insulator 16, are formed in multiple stages at a predetermined pitch in the axial direction, with the circumferentially-continuous annular shelf portion 17 being formed between adjacent upper and lower grooves 21. Upon forced cooling of the heaters, a cooling medium can enter a space behind the heater elements 18, enabling effective cooling of the heater elements 18. Air or nitrogen gas, for example, may be used as the cooling medium.

In the heater 18A provided in each of the unit areas A₁ to A₁₀, those heater elements 18 which lie on the terminal side are connected to an external heater power section 18B via terminal plates 22a, 22b that penetrate radially through the heat insulator 16.

As shown in FIG. 1, the outer circumferential surface of the heat insulator 16 of the furnace body 5 is covered with an outer shell 28 made of a metal, such as stainless steel, in order to retain the shape of the heat insulator 16 and, in addition, to reinforce the heat insulator 16. The outer circumferential surface of the outer shell 28 may be covered with a water-cooling jacket 30 in order to reduce the thermal influence of the furnace body 5 on the external environment. An upper heat insulator 31 which covers the top of the heat insulator 16 is provided on the top of the heat insulator 16, and a stainless steel top board 32 which covers the top (upper end) of the outer shell 28 is provided on the upper surface of the upper insulator 31.

As shown in FIGS. 1 and 2, in order to rapidly lower the temperature of a wafer after heat treatment, thereby speeding up processing and increasing the throughput, the furnace body 5 is provided with a heat release system 35 for discharging the atmosphere in the space 33 to the outside, and a forced cooling means 36 for introducing a cooling medium at room temperature (20-30° C.) into the space 33 to forcibly cool the space 33. The heat release system 35 is, for example, comprised of an exhaust port 37 provided at the top of the furnace body 5, and to the exhaust port 37 is connected a cooling medium exhaust line 62 for exhausting the cooling medium from the space 33.

The forced cooling means 36 includes a plurality of annular flow passages 38 formed between the heat insulator 16 and the outer shell 28 and arranged in the height direction of the furnace body 5, and a plurality of cooling medium outlets 40, penetrating through the heat insulator 16, for ejecting the cooling medium into the space 33. The annular flow passages 38 are formed by attaching band-like or annular heat insulators 41 to the outer circumferential surface of the heat insulator 16, or by annularly grinding the outer circumferential surface of the heat insulator 16.

A common supply duct 49 for distributing and supplying the cooling medium to the annular flow passages 38 and which extends in the height direction of the furnace body 5, is provided on the outer circumferential surface of the outer shell 28. The outer shell 28 has communication holes for communication between the supply duct 49 and the annular flow passages 38. To the supply duct 49 is connected a cooling medium supply line 52 for supplying the cooling medium.

As described above, the outer temperature sensors 50 for detecting the temperatures of the areas A₁ to A₁₀ are provided in the space 33 formed between the furnace body 5 and the processing container 3. A detection signal from each temperature sensor 50 is sent to a controller 51 via a signal line 50a. The controller 51 controls the heater power section 18B and drives the heaters 18A each provided in each of the unit areas A₁ to A₁₀.

A temperature sensor (exhaust temperature sensor) 80 is provided also in the exhaust port 37. A detection signal from the temperature sensor 80 is sent to the controller 51 via a signal line 80a.

As shown in FIGS. 1 and 2, a plurality of inside temperature sensors (T/Cs) 81, arranged in the longitudinal direction of the inner cylinder 3A, are provided on the inner surface of the inner cylinder 3A. The inside temperature sensors 81 are held by an inside temperature sensor holding tool 81A which extends longitudinally in the inner cylinder 3A. A plurality of inner temperature sensors (T/Cs) 82, arranged in the longitudinal direction of the outer cylinder 3B, are provided on the inner surface of the outer cylinder 3B. The inner temperature sensors 82 are held by an inner temperature sensor holding tool 82A which extends longitudinally in the outer cylinder 3B. Further, a vertically-extending profile temperature sensor holding tool 83A is installed on the lid 10. To the sensor holding tool 83A are mounted a plurality of profile temperature sensors (T/Cs) 83.

The inside temperature sensors 81 and the inner temperature sensors 82 are to detect interior temperatures of the processing container 3. Each inside sensor 81 and each inner sensor 82 are provided for each of the unit areas A₁ to A₁₀. In the case of a processing container 3 having a single-tube structure, only inner sensors 82 may be provided.

The profile temperature sensors 83, mounted to the profile temperature sensor holding tool 83A installed on the lid 10, are inserted into the processing container 3 together with the lid 10 and the boat 12, and function as in-container temperature sensors for detecting interior temperatures of the processing container 3. When the boat 12 is inserted into the processing container 3, each of the profile temperature sensors 83 lies at a position corresponding to each of the unit areas A₁ to A₁₀.

Of the temperature sensors 50, 80, 81, 82, 83, the exhaust temperature sensor 80, the outer temperature sensors 50, the inside temperature sensors 81 and the inner temperature sensors 82 are connected to the controller 51. The profile temperature sensors 83 are connected to a temperature estimation section 51A which estimates the temperatures of wafers W upon their loading. The temperatures of wafers W upon their loading, estimated by the temperature estimation section 51A, are sent to the controller 51. Based on the temperatures of wafers W upon their loading, estimated by the temperature estimation section 51A, and on temperatures detected by the temperature sensors 50, 80, 81, 82, the controller 51 controls the heater power section 18B which drives the heaters 18A.

The operation of the heat treatment apparatus having the above construction will now be described.

First, wafers W are loaded into the boat 12, and the boat 12 loaded with the wafers W is placed on the heat-retaining cylinder 11 on the lid 10. Thereafter, the lid 10 is raised by means of the lifting mechanism 13A and the boat 12 is carried into the processing container 3, whereby the wafers W are inserted and loaded into the processing container 3.

The temperature estimation section 51A determines the temperatures of the wafers W upon the loading of the wafers W. Based on the wafer temperatures determined by the temperature estimation section 51A, the controller 51 controls the heater power section 18B, thereby driving and controlling the heaters 18A each provided in each of the unit areas A₁ to A₁₀. The space 33 between the furnace body 5 and the processing container 3 is thus heated to perform an intended heat treatment of the wafers W held in the boat 12 in the processing container 3.

After the wafer loading is completed and the temperatures of the wafers W are stabilized, the controller 51, based on the wafer temperatures determined by the temperature estimation section 51A and optionally on temperatures detected by the temperature sensors 50, 80, 81, 82, controls the heater power section 18B to drive and control the heaters 18A in the unit areas A₁ to A₁₀.

The operation of the temperature estimation section 51A upon loading of wafers W will now be described with reference to FIGS. 3 and 4.

FIG. 3 is a graphical diagram illustrating the operation of the temperature estimation section 51A. In the graph of FIG. 3, the abscissa represents time upon loading of a wafer W, and the ordinate represents temperature.

As shown in FIG. 3, the temperature of the wafer W stabilizes after a certain period of time has elapsed from the start of loading of the wafer W.

A temperature detected by a profile temperature sensor 83 is inputted into the temperature estimation section 51A during the wafer loading period from the start of loading of the wafer W until the stabilization of the wafer temperature.

Based on the temperature detected by the profile temperature sensor 83, the temperature estimation section 51A estimates the temperature of the wafer W.

More specifically, the temperature estimation section 51A applies a first-order lag filter to the detection temperature (detection signal) from the profile temperature sensor 83.

An appropriate filter, which has been designed based on a wafer temperature time constant, is set as the first-order lag filter. The use of such an appropriate first-order filter can make a detection signal from the profile temperature sensor 83, to which the filter is applied, approximately equal to the actual temperature of the wafer.

The advantageous effects of the present invention will now be described with reference to FIGS. 4(a) and 4(b). FIG. 4(a) is a diagram illustrating the action of the temperature estimation section of the heat treatment control system according to the present invention, and FIG. 4(b) is a diagram illustrating the action of a comparative control system.

As shown in FIG. 4(a), according to the present invention, the temperature estimation section 51A estimates the temperature of a wafer W upon its loading by applying a first-order lag filter to a detection signal from a profile temperature sensor 83 which is mounted on the lid 10 and has been inserted into the processing container 3 together with the wafer W. The temperature to which the first-order lag filter is applied is close to the actual temperature of the wafer W. Thus, the temperature of the wafer can be determined accurately. Based on the temperatures of wafers W thus determined by the temperature estimation section 51A, the controller 51 controls the heater power section 18B and drives the heaters 18A upon loading of the wafers W. This can stabilize the temperatures of the wafers W upon their loading in a short time.

Referring to FIG. 4(a), the detection temperature of an inner temperature sensor 82 is considerably higher than the actual temperature of the wafer upon its loading.

In the comparative control system shown in FIG. 4(b), on the other hand, a controller drives and controls a heater upon loading of wafers based on a detection signal from an inner temperature sensor. As shown in FIG. 4(b), the detection temperature of the inner temperature sensor considerably differs from the actual temperature of the wafer. Thus, it takes a long time for the comparative control system to stabilize the temperatures of wafers W.

The following may be the reason why it takes a long time for the comparative control system to stabilize the temperatures of wafers W: Wafers W are at room temperature at the start of loading of the wafers W, whereas the detection temperature of an inner sensor is near the processing temperature. When the controller controls a heater based on the detection temperature of the inner sensor, it is not possible to employ a large heater power because of the large difference between the wafer temperature and the detection temperature. Thus, the wafers W cannot be heated strongly enough.

Wafers, composed of Si, are transparent to infrared light at low temperatures below 400° C. Thus, wafers have a low emissivity and are hard to heat up. For example, in a 200° C. process, the emissivity of Si is around 0.1 in a heater wavelength range of 1.5 to 5.0 μm. Thus, an Si wafer cannot be easily heated up.

According to the present invention, on the other hand, the temperature estimation section 51A can determine with good accuracy the temperatures of wafers W upon their loading. Based on the temperatures of the wafers W, determined by the temperature estimation section 51A, the controller 51 controls the heater power section 18B and drives the heaters 18A. This can stabilize the temperatures of the wafers W in a short time.

As described hereinabove, according to this embodiment, the temperatures of wafers W upon their loading can be estimated with good accuracy by applying a first-order lag filter to a detection signal from each profile temperature sensor 83 by means of the temperature estimation section 51A. The controller 51, based on the wafer temperatures estimated by the temperature estimation section 51A, controls the heater power section 18B and drives the heaters 18A.

Because the temperature estimation section 51A can estimate with good accuracy the temperatures of wafers W upon their loading, the temperatures of the wafers W can be estimated correctly and the wafers W can be heat treated quickly and accurately upon loading of the wafers W as compared to the case where detection temperatures from e.g. inner temperature sensors 82 are estimated to be the temperatures of the wafers W and the controller 51 controls the heaters 18A based on the estimated wafer temperatures.

Though in this embodiment the profile temperature sensors 83 are used as in-container temperature sensors to be inserted into the processing container 3 together with wafers W, and the profile temperature sensors 83 are mounted to the profile temperature sensor holding tool 83A installed on the lid 10, it is also possible to provide the profile temperature sensors 83 in the boat 12.

What is claimed is:

1. A heat treatment control system comprising:
a furnace body;
a heating section provided in the inner surface of the furnace body;
a processing container disposed in the furnace body and having a bottom opening;
a vertically movable lid configured to hermetically close the bottom opening of the processing container;
a holding tool, provided on the lid, configured to house a plurality of objects to be processed and insert the objects to be processed into the processing container;
an in-container temperature sensor to be inserted into the processing container together with the objects to be processed to detect the internal temperature of the processing container;
a temperature estimation section configured to estimate the temperature of an objects to be processed by applying a first-order lag filter to a detection signal from the in-container temperature sensor; and
a controller configured to control the heating section based on the temperature of the object to be processed, estimated by the temperature estimation section.

2. The heat treatment control system according to claim 1, wherein the in-container temperature sensor is provided on the lid.

3. The heat treatment control system according to claim 1, wherein the in-container temperature sensor is mounted to a holding tool.

4. The heat treatment control system according to claim 1, wherein the temperature estimation section estimates the temperature of the object to be processed upon loading of the object to be processed into the processing container.

5. A heat treatment control method using the heat treatment control system comprising: a furnace body; a heating section provided in the inner surface of the furnace body; a processing container disposed in the furnace body and having a bottom opening; a vertically movable lid configured to hermetically close the bottom opening of the processing container; a holding tool, provided on the lid, configured to house a plurality of objects to be processed and insert the objects to be processed into the processing container; an in-container temperature sensor to be inserted into the processing container together with the objects to be processed to detect the internal temperature of the processing container; a temperature estimation section configured to estimate the temperature of an object to be processed by applying a first-order lag filter to a detection signal from the in-container temperature sensor; and a controller configured to control the heating section based on the temperature of the object to be processed, estimated by the temperature estimation section, said method comprising the steps of:
inserting and loading an object to be processed into the processing container by using the holding means configured to house and hold the object to be processed;
estimating the temperature of the object to be processed by means of the temperature estimation section by applying a first-order lag filter to a detection signal from the in-container temperature sensor; and
controlling the heating section with the controller based on the temperature estimated by the temperature estimation section.
